(19) United States
(12) Patent Application Publication
(10) Pub. No.: US 2009/0080300 A1
(43) Pub. Date: Mar. 26, 2009

(54) Data transmission method, optical disc recording method and optical disc recording apparatus

(75) Inventor: Hiroshi Hirayama, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 12/080,190

(22) Filed: Mar. 31, 2008

(30) Foreign Application Priority Data
Sep. 25, 2007 (JP) 2007-246489

(51) Int. Cl. H04L 12/56; G11B 20/10

(52) U.S. Cl. 369/47.23; 370/389

(57) ABSTRACT

A data transmission method for a large amount of contents information, comprises the following steps of:
dividing contents data into a data block of fixed length or variable length, and conducting coding process on each thereof;
transmitting identification information of the contents, to which the data block belongs,
and first header information for managing sequence within the contents, when transmitting the data block;
and transmitting second header information for managing the sequence within the contents of said data block, when transmitting each data block,
thereby providing a data transmission method suitable for when transmitting a large amount of contents data via a network,
an optical disc recording method and apparatus, enabling to manage recording status of the optical disc for the contents, corresponding to the transmission method thereof.

### BACKGROUND OF THE INVENTION

The present invention relates to a data transmission method, an optical disc recording method and an optical disc recording apparatus.

Distribution of contents data, such as, movies recorded on a DVD (Digital Versatile Disc), etc., is not only to distribute by read-only optical disc,

but there can be also considered a way of distribution, i.e., they are accumulated within a server in such a format that can be recorded on an optical disc, as they are, and are transmitted through a network, thereby to be recorded on an optical disc as download data.

For the transmission of contents data is necessary a system for transmitting that preventing from reuses of the data, expect for the use of the optical disc, a target the transmission thereof.

The system for preventing from reuse of the transmission data is already known, for example, in the following Patent Document 1.

[Patent Document 1] Japanese Patent Laying-Open No. 2006-268353 (2006)

### BRIEF SUMMARY OF THE INVENTION

When transmitting the contents data through the network, it is difficult to ensure or guarantee a transmission rate, always, due to difference in transmission band in each transmission path on the way of transmission, an increase of traffic on the transmission path, and/or concentration of accesses to a server, etc.

On the other hand, the DVD has a capacity for the movie contents of about 2 hours (approximately, 4.7 G bytes on SD picture quality), but if an effective value of the transmission rate is 10 Mbps (1.25 MB/s), then it necessitates a transmission time of around 1 hour.

It is undesirable to occupy a portion of the transmission band for a long time.

On the other hand, in case of the network transmission, upon the data to be transmitted is conducted coding, for preventing the data from the secondary use on the way of the transmission thereof, or compression process for lightening the traffic on the transmission path (including a purpose for archiving a plural number of data, therein).

Those encoding and compressing processes must be completed by a certain unit, and when releasing it from the encoding or expansion process on it, it is necessary to receive all of data of that data unit, on the transmission.

For example, when conducting the encoding process or the compressing process, by a DVD contents unit of 4.7 GB, and when an obstruction is generated on the transmission (there can be considered a stoppage of transmission data from the server, hang-up, a hardware obstruction on the transmission network, data defect due to a streaming transmission having less overhead on transmission protocol, etc.), at the worst, it is necessary to transmit the data, again, from a head thereof.

Accordingly, there is necessity of a transmission method for use of a large amount of data (i.e., the contents data), being suitable for a transmission path, upon which high-speed and stable transmission cannot be expected for a long time-period.

Further, in case when applying a large amount of data as a unit, in the encoding or the compressing process thereof, there is a problem that, a buffer memory having large capacity is necessary for achieving temporary storage of the transmission data, so as to release it from the encoding, and/or conduct the expansion process thereon.

In this case, there is stored the data, having a meaning as the contents that are released from the encoding, and then there is a danger that it is placed at the secondary use, other than being recorded on the optical disc.

The above-mentioned is also true for recording the transmission data onto the optical disc, i.e., it is impossible to conduct the recording unless all of contents are completed.

Accordingly, it is impossible to recode the data, which is received up to that time, onto the optical disc, on the way of data transmission, as well as, reproduction thereof (i.e., viewing the contents), and this comes to be a reason for causing a user to feel inconvenience.

Accordingly, an object of the present invention is to provide an data transmission method, an optical disc recording method and an optical disc recording apparatus, for dissolving such the problem(s) mentioned above.

For accomplishing the object mentioned above, according to the present invention, there is provided a data transmission method for a large volume of contents information, comprising the following steps of:

dividing contents data into a data block of fixed length or variable length, and conducting coding process on each thereof;

transmitting identification information of the contents, to which the data block belongs, and first header information for managing sequence information within the contents, when transmitting the data block;

and transmitting second header information for managing the sequence within the contents of said data block, when transmitting each data block.

Also, for accomplishing the object mentioned above, according to the present invention,

there is also provided an optical disc apparatus for recording contents information onto an optical disc, while receiving the contents information, which is transmitted through a network, comprising, at least:

an interface unit, which is configured to request data transmission to a source of contents, and to receive;

a detect unit, which is configured to detect header information including sequence information of data blocks, each being a unit of transmission, within the contents;

a buffer unit, which is configured to accumulate the data blocks transmitted, temporarily, and to transmit them onto an optical disc;

and a buffer control unit, which is configured to control write-in and readout into/from said buffer unit, wherein said buffer control unit maintains a buffer area and controls the write-in and the readout of the data block, by a unit of the data block received, and wherein the buffer are a completing transmission to the optical disc is releases, thereby dissolving the problem.

According to the present invention, for the contents data, it is divided into a data format suitable for transmission via a network,

and also is transmitted with adding head information for managing the sequence of data divided; therefore,

it is possible to manage the data sequence at a receiver, and thereby enabling data transmission and recording onto the optical disc while maintaining the data sequence for the contents.

Further, transmitting a large amount of contents in the form of divided data enables recording of the data, which was transmitted up to now, onto the optical disc, in particular, in case when interrupting the recording, such as, generating an obstacle during the transmission.

Further, with maintaining the buffer only for the divided data to be transmitted and releasing it, waiting until completion of write-in and transmission of the transmitted data onto the optical disc, it is possible to save the buffer capacity required for decoding process to encoding or compression, etc.

Further, brining the data, existing within the buffer on the receiver, into data of a small amount, having no meaning as the contents data, it is possible to suppress the secondary use of the contents data.

Furthermore, with recording a management table, for managing the recording status onto the optical disc for all of the divided data, building up the contents, on the optical disc, transmission request for the non-recorded contents data and recording thereof onto the optical disc can be made, in case when loading it, again, after ejecting the optical disc, while interrupting the recording on the transmission of contents.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a view for showing the structures of an optical disc recording apparatus, according to an embodiment of the present invention;

FIG. 2 is a view for explaining a transmission method for contents data;

FIG. 3 is a view for explaining the structures and processing of a data buffer for transmission data;

FIG. 4 is a flowchart for explaining a control method for the data buffer;

FIG. 5 is a view for explaining a buffer control method when transmitting through a plural number of channels;

FIG. 6 is a view for explaining regional structures, a recording method and a download management table of an optical disc; and

FIG. 7 is a flowchart for explaining an optical disc recording method of divided data.

### DESCRIPTION OF THE PREFERRED EMBODIMENTS

Hereinafter, embodiments according to the present invention will be fully explained by referring to the attached drawings.

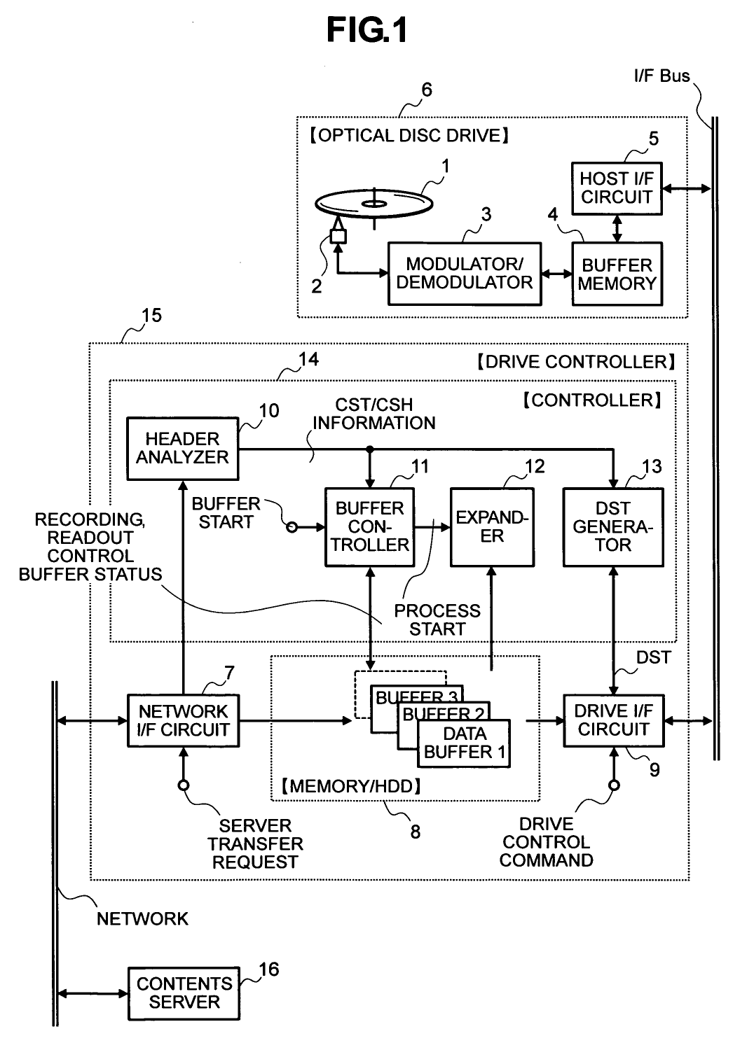

FIG. 1 is a block diagram of an apparatus, for showing a first embodiment, in relation to a data transmission method, an optical disc recording method and an optical disc recording apparatus,

according to the present invention. In this figure,

a reference numeral 1 depicts an optical disc, on which contents data transmitted through a transmission channel (i.e., a network) is recorded,

2 an optical head for reading/writing of record makes on the optical disc,

3 a modulation/demodulation circuit for encoding the transmission data into signals suitable for recoding on the optical disc 1, through modulation process thereon, and for decording the data into original one before modulation when reproducing,

4 a buffer memory for use of interleave process suitable for recording on the optical disc 1 and addition of error correction codes, etc., and de-interleave or an error correction process upon demodulated data,

5 a host I/F circuit for controlling data transfer on an I/F bus,

and those elements build up an optical disc drive 6.

Next, explanation will be made on the structures of a drive control unit 15, for recording/reproducing control for the optical disc drive 6 and data transfer control upon the contents data stored within a contents server 16.

A reference numeral 7 depicts a network I/F circuit for transmission of the data control upon the network, and

8 a data buffer for storing transfer data received, temporarily, and this is achieved by semiconductor memory and/or a hard disc drive.

Further mode in the data butter independent areas for each transmission unit (i.e., data buffers 1, 2, 3 . . . , N) are maintained.

A numeral reference 9 depicts a drive I/F circuit for controlling data transfer to the I/F bus and for controlling data transfer between the optical disc,

10 a header analysis circuit for detecting header information, which is added when the contents data is transferred from the contents server 16 for managing the sequence of the data transfer, etc., so as to analyze the contents thereof,

11 a buffer control circuit for controlling writing/reading of the transfer data for the data buffer 8,

12 an expansion circuit for conducting a decoding and an expansion process against compression process, upon the data written into the data buffer,

13 a DST generator circuit for generating a table (DST: Download Status Table) for managing recoding status onto the optical disc, with respect to the contents data, and

14 is a controller, including those elements therein, which can be achieved by, not only circuit, but also a program control with using a micro-computer therein.

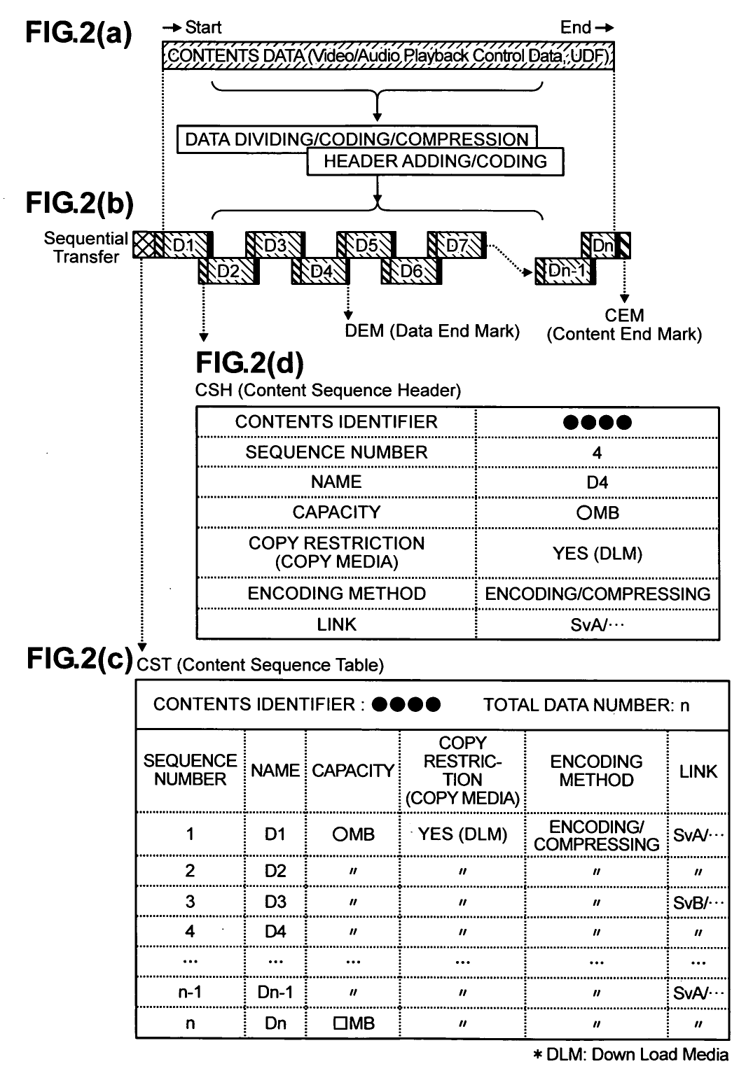

Explanation will be given on a transmission method of the contents data, which is transferred from the contents server 16, within the apparatus shown in FIG. 1, by referring to FIG. 2.

In FIG. 2, (a) depicts the contents data, such as, movies or the like, to be downloaded onto the optical disc 1, and there are also included video audio information, application data, such as, a play list and so on to be used in reproduction control, and further file format information, such as, accesses to the optical disc, UDF (Universal Disc Format), etc.

For this one series of contents data, a long time occupation of the transmission band is avoided on the network, and also when the traffic is clouded, the data is divided in such an extent that the data transmission can be completed, easily.

For example, as a unit of division it is assigned from several tens MB (byte) to several hundreds MB (for example, when a transfer rate of the network is 10 Mbps (bit per second, 1.25 MB/s) and the time of transfer is about 1 minute, then it is about 75 MB)

As a unit of division can be considered, for example, a fixed length unit or a variable length but, but in FIG. 2 is shown the case where dividing is made by fixed length and therefore only the last data is different from others, which cannot be divided by that.

Further, when the data is transferred through the network, coding processes, such as, encoding and compression, etc., are conducted by a unit of that divided data, for the purpose of protecting the contents data from the secondary use thereof within a relay server and also shortening the transmission time.

Since sometimes contents data is compressed, originally, upon the video data and audio data on the basis of MPEG method or the like, then there are sometimes cases where the compression process is not conducted for the divided data.

The data after being divided is transferred through the network, but it is preferably that the contents data should be maintained in its order or sequence thereof when being recorded onto the optical disc, from view points of accessing of the contents data when reproducing the optical disc and reproduction thereof.

Accordingly, a contents sequence table (CST) is generated and added at the head of the contents data, and further at a head of the divided data a contents sequence header (CSH) including identification information of sequence to the contents data.

Further, there are added a data end mark (DEM) for identifying an end of transfer of the divided data and a contents end mark (CEM) for identifying and end of the contents, respectively.

There are cases where those CST and CSH are coded, thereby preventing the contents from being used for the purposes other than transferring to the optical disc (see FIG. 2(b)).

Explanation will be made on examples of CST and CSH, by referring to FIGS. 2(c) and 2(d).

In FIG. 2(c), CST is made up with the followings: i.e., sequence numbers for indicating the order or sequence of the divided data from the head to the end of the contents, information necessary for data transfer of the name of the divided data and data capacity, copy controls for the contents data, being each of divided data, a coding method, server information about a source of transmission and information necessary for processing the divided data, and further information for identify the contents itself, and total number information of the divided data.

In the example shown in FIG. 2(c), the sequence numbers indicate the sequence of the divided data corresponding to, i.e., from the head of the contents to the end thereof,

and from that information and a name of the divided data, and the information relating to the capacity, they are used in transmission control to the optical disc.

Further, with each of the divided data, i.e., items of the copy control information for the contents data, and also the coding method thereof,

they indicate the case where the destination of transfer is limited to a download medium (i.e., an optical disc), the data is encoded, and compressed thereupon.

Further, as link information of each of the divided data is added information, such as, a server name of the source of transfer and/or access address, etc.

In FIG. 2(c) is shown the case where each of the divided data differs from each other in the source of transfer.

As the link information, it should not be restricted only one source of transfer or address information, it can be considered that two (2) or more of the information are stored, to be used for selection of an access destination when a transmission request is made on the divided data.

On the other hand, as the information relating to the contents data, which is built up with a plural number of divided data is given the contents identification information.

For example, it corresponds to the information relating to a title of movie, or a management code thereof, etc., being managed on the contents server. Further, there is given the information about the total number of the divided data.

Next, in CSH shown in FIG. 2(d) are stored the information, including the sequence numbers unique to the divided data, which will be transferred thereafter, for example. The items of the information are same to that of CST, and are used in a process for the divided data.

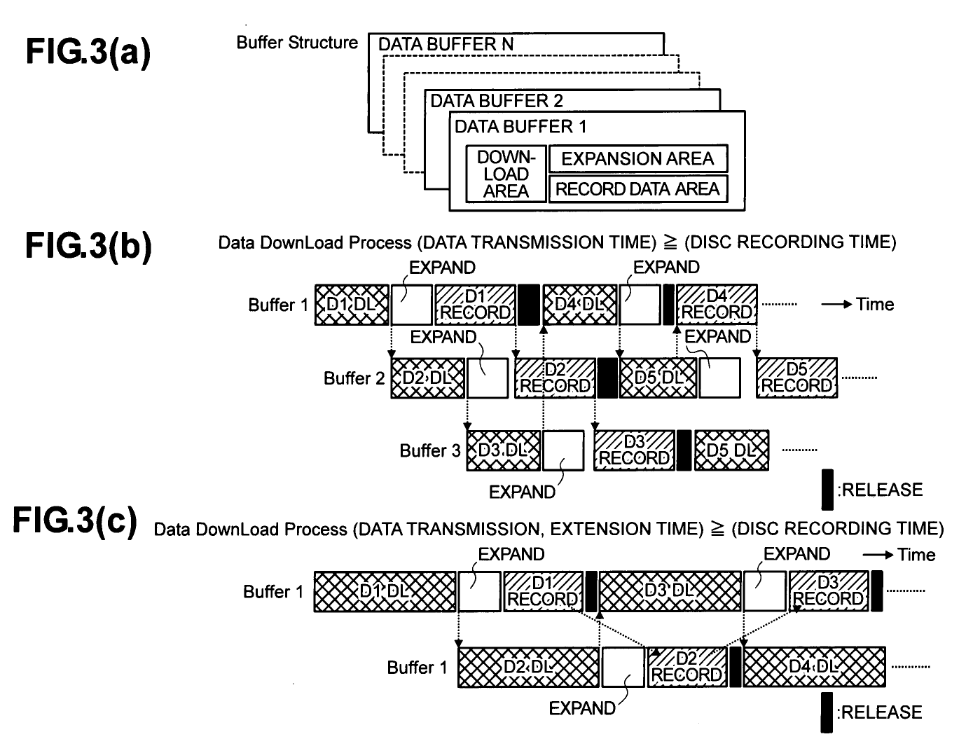

Receiving and buffering are conducted upon each of the divided data, which are transferred through the network with the method explained in the above, and explanation will be given about a data transmission control onto the optical disc, by referring to FIGS. 3(a) to 3(c).

FIG. 3(a) shows an example of the structures of a data buffer 8 for accumulating the divided data therein, temporally. The data buffer is made up with a download area for temporally accumulating the divided data, which is received by the network I/F circuit 7, an expansion area for decoding the divided data from the coding, and for accumulating the divided data after expansion process thereon, and a recoding data area.

Further, there is a case where a plural number of the data buffers are maintained in accordance of the receiving condition of the divided data.

As the data buffer can be considered, for example, a high-speed large-capacity memory device, such as, a hard disc drive, representatively, or a semiconductor memory, etc.

Maintenance of each area for the data buffer 8, writing the data into that area, and readout thereof are controlled by means of the buffer control circuit 11.

With the maintenance of the data buffer area, in particular, in case of using the hard disc drive therein, there is no necessity that it is within the data buffer area or that the plural number of the data buffers are continuous recording areas,

but desirably, it/they are maintained on an outer zone, where the transmission rate is high, for brining the times for writing and readout to be the minimum,

because of an increase of accesses, such as, writing of the received data, the expansion process, readout of the transmission process data onto the optical disc, etc.

in particular, in the case of the hard disc drive adapting CAV (Constant Angular Velocity) method.

Furthermore, it is desirable that they are continuous or close to each other in the areas, so as to bring the head movement of the hard disc drive to be the minimum.

Next, explanation will be made on a process upon the divided data, which is received by the network I/F circuit 7, according to the control by means of the buffer control circuit 11.

FIG. 3(b) shows a process where the transfer time of the divided data from the contents server 16 is shorter than a recording time on the optical disc for the data after expansion thereof.

The buffer control circuit 11, first of all, maintains a data buffer 1 within the data buffer 8, and starts writing of the divided data into the download area responding to detection of CSH.

And, it detects DEM indicate of an end of the divided data or writes a data capacity indicated by CST and/or CSH, then it completes the data storage into the download area.

The buffer control circuit 11 starts the expansion circuit 12 with using an area just after the download area, for example, and conducts the decoding and the expansion processes while reading out the data stored in the download area, thereby writing into the expansion area.

After completing the writing into the expansion area, the buffer control circuit 11 conducts transfer of the expanded data to the optical disc through the drive I/F circuit 9.

On the other hand, responding to completion of the writing into the download area of the data buffer 1, the buffer control circuit 11 newly maintains the data buffer 2,

and requests the transmission of divided data to the next sequence number through the network I/F circuit 7.

Responding to completion of the expansion process to the next divided data within the data buffer 2 and completion of the data transfer to the optical disc within the data buffer 1, the transfer is started on the data, which is stored within the data buffer 2, to the optical disc.

Similar processing is conducted, herein after, but determination on necessity of maintaining the data buffer, newly, is conducted by confirming a status (i.e., condition) for other data buffer(s) maintained before, when completing the writing into the download area.

In case where the status is in a released condition, e.g., the data transmission is completed of that data buffer area to the optical disc,

and an overwrite can be made of other data, the data buffer is not maintained, newly,

but the data buffer area in the released condition is used as the data buffer for the next divided data.

If there is no data buffer area in the released condition, the data buffer is maintained, newly.

In FIG. 3(b), since there is no data buffer area in the released condition when completing the writing of the divided data into the data buffer 2, then a data buffer 3 is maintained, newly.

Since the data buffer is in the released condition when completing the writing of the divided data into the data buffer 3, the transfer process of the divided data is started into the data buffer area 1.

FIG. 3(c) shows a process in such a transfer condition that the transfer time of the divided data from the contents server 16 is longer than the recording time on the optical disc for the data after expansion thereof. Maintenance of the data buffer and the process thereof are same as those, which are explained by referring to FIG. 3(b).

However, the buffer control circuit 11 maintains the sequence number, which is detected within the header analyzer, when reading the divided data into each of the data buffers, and correspondence to the buffer area for each of the divided data maintained within the data buffer, and it adjusts the sequence of transfer of the divided data to the optical disc by controlling the readout of the data buffer upon basis of that information when transmitting to the optical disc.

Control is made upon the readout for the data buffer areas, in accordance with the sequential order.

Also, the processes within the data buffer should not be restricted only to that explained above, but for example, depending on the compression process, when the sequences of the divided data inputted into the expansion circuit 12 and the transfer data onto the optical disc to be outputted are corresponding one by one,

It is not necessary to maintain the expansion area within the data buffer, and then it is possible to save the buffer capacity.

This is effective, in particular, when using the semiconductor or the like, having a limitation of the memory capacity thereof, as the data buffer.

Further, it is not necessary to process, such as, the readout and the write-in of the expanded data with respect to the data buffer,

and then it is possible to reduce the number of times of access to the buffer, conducted within the expander, and also to reduce an overhead time until the data transfer onto the optical disc.

In FIGS. 3(b) and 3(c), the time required in a part of the expansion process becomes needless, i.e., it is only of a storing time of transfer data into the download area and a read-out time for conducting the data transfer onto the optical disc.

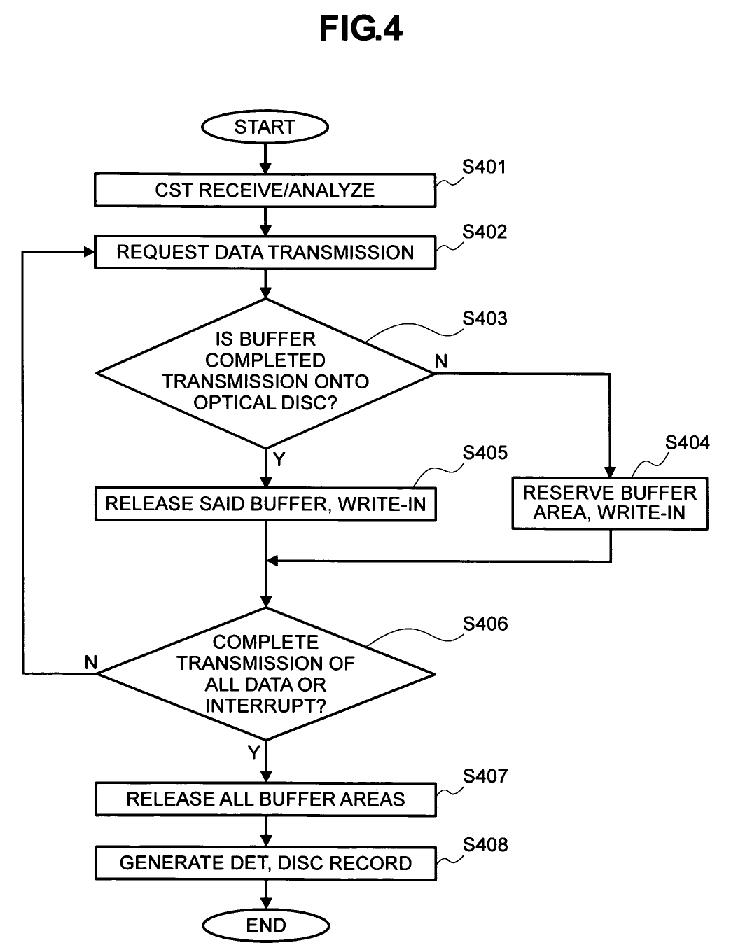

A flowchart shown in FIG. 4 shows a control method of the data buffer 8 by the buffer controller 11.

In FIG. 4, S401 detects CST included within a first transfer data from the contents server 16, to analyze the contents thereof within the header analyzer 10, i.e., analyzing the information, such as, the contents identification information, a number of data, the sequence, etc.

Next, the transfer request for divided data from the head thereof is requested to the contents server 16 through the network I/F circuit 7 (S402).

On the other hand, the buffer controller 11 maintains the download area for the transfer data, etc., within the data buffer 8 (see FIG. 3(a)),

but also confirms on presence/non-presence of the data buffer that has already completed the data transfer thereof (S403)

In case that there is no data buffer, already having completed the data transfer in the step S403, then a data buffer is maintained, newly,

and thereby conducting the data transfer onto the optical disc through writing and readout of the transferred data (S404)

In case where there is the data buffer in S403, after changing that buffer area into the released status, the transfer is conducted onto the optical disc (S405).

Further, after completing the transfer of all the divided data for the contents or transfer a part thereof, in the step S406, (for example, in case where traffic is crowded on the network, or the transfer rate thereof is deteriorated, remarkably, or in case when a user stops the data transfer on the way of transfer of the contents, upon compiling a program for the contents, the contents, which an be downloaded, is released, sequentially, by taking a time lag, and there can be considered cases, etc., where finally it comes to one (1) piece of content), then all of the data buffers are released in the condition thereof.

The buffer areas turning into the released status can be overwritten, for example, with the transferred other data, or data having no relation with the contents.

Further, upon basis of CST, which is received and analyzed in the step S401, a download status table (DST) is generated within the DST generator 13, and is recorded on the optical disc dive through the driver I/F circuit 9 (S408).

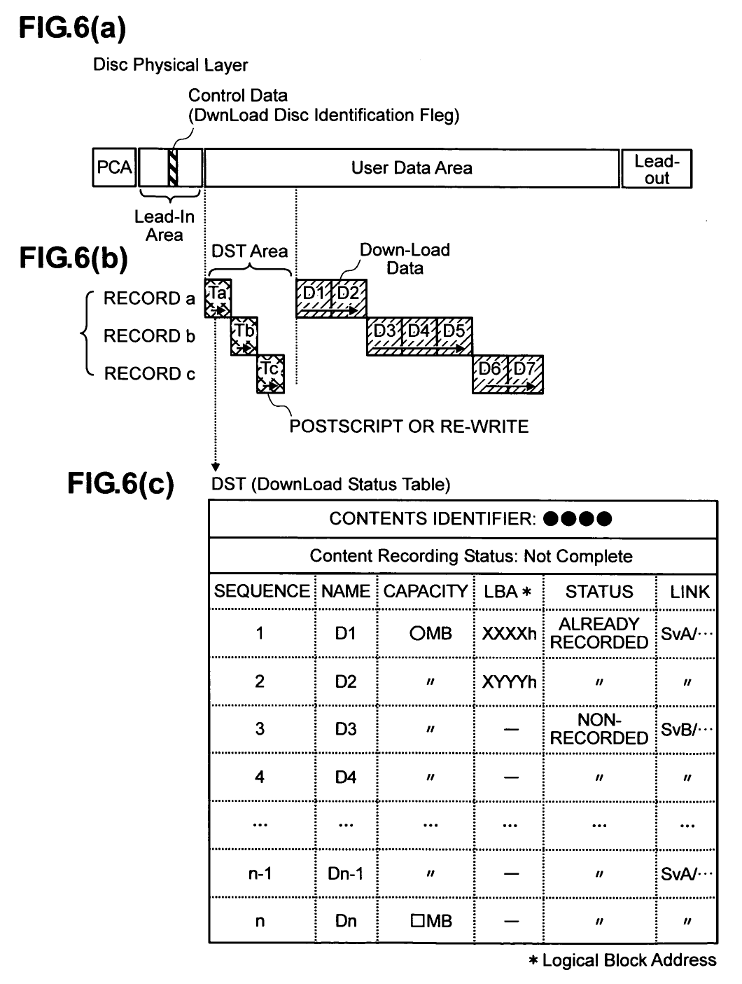

Since details of DST will be explained, later, by referring to FIG. 6, and therefore the explanation thereof will be omitted herein.

In a step S406, in case of continuing the transfer of the divided data, the processes starting from the step S402 will be conducted, continuously.

By transmitting the contents as the divided data, and controlling the write-in and readout thereof into/from the data buffer,

it is possible to conduct the control upon the data transfer onto the optical disc, while maintaining the sequence of the divided data with respect to the contents.

Further, by turning the buffer area into the released area upon completion of the write-in or the readout process of the divided data,

so as to use it as the data buffer in the next data transmission, etc.,

it is possible to make the secondary use difficult other than recording purpose onto the optical disc, while remaining only the minimum contents data in the recording area other than the optical disc, e.g., the recording target.

### Embodiment 2

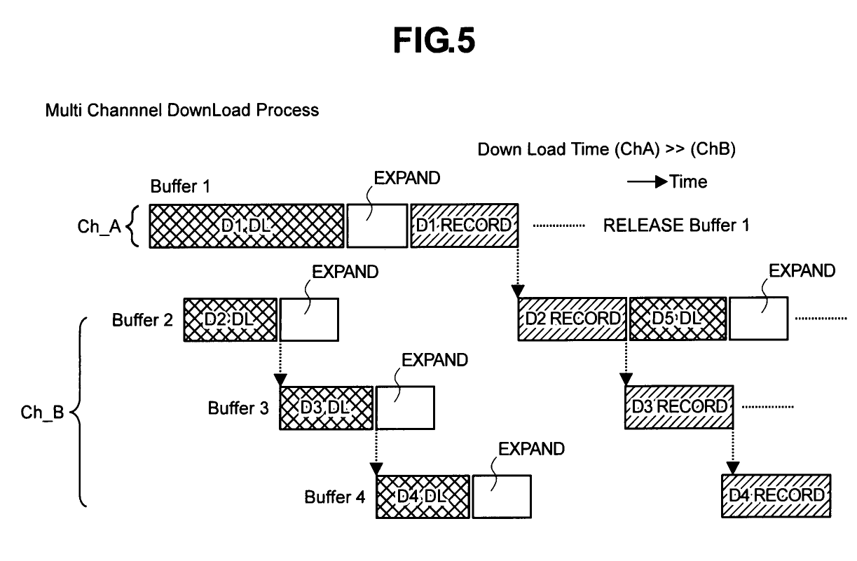

FIG. 5 shows other example of the data buffer control, which was explained by referring to FIGS. 3(a) to 3(c).

This FIG. 5 shows the data buffer control, for example, in a case that transmission of a plural number of divided data is requested to the contents server 16 shown in FIG. 1, or in case that transfer request of the divided data is made to other server, etc., accumulating the same contents data therein, from the link information included within CST.

As the structures of the data buffer, and the control method thereof are applied those shown in FIG. 3(a) and FIG. 4, and the explanation thereof will be omitted herein.

In FIG. 5, a transfer request of continuous divided data is requested to the contents server 16 through the network I/F circuit 7,

for example, with using a plural number of channels, i.e., channels A and B, among the transfer channels within the network.

The buffer control circuit 11 conducts the write-in or the readout of the divided data into/from the data buffer in the order of reception thereof, and thereby conducting the data transfer onto the optical disc.

In FIG. 5 is shown a case where, for example, the transmission speed of the channel A is delayed, greatly, comparing to that of the channel B, due to access concentration to the server or traffic jam or confusion on the way of the network.

As the transfer channel is selected “A” and the data buffer 1 is maintained, thereby continuing the write-in of the transfer data.

On the other hand, for the channel B is maintained the data buffer 2, while on the channel A is conducted the write-in process of the data following to the divided data on the way of transfer.

Also, in case of the write-in into the data buffer 1 or the readout with transfer onto the optical disc is still continuing after completion of the write-in into the data buffer 2, the buffer controller 11 maintains the data buffers 3 and 4, newly, one by one, and thereby conducting the transmission of the next divided data with using the channel B.

The data transfer onto the optical disc for the data buffer 2 or thereafter is conducted waiting the completion of the data transmission process for the data buffer 1.

Further, in this one example, after completing the process for the data buffer 1, it is turned into the released status, and the transfer of the divided data is requested with using the channel B, but not using the channel A, being slow in the transmission speed.

However, there can be considered cases, for example, releasing the data buffer with stopping the transfer on the channel A, being slow in the transfer rate,

so as to conduct the data transfer, again, from the head of contents,

or requesting the divided data after the data remaining within the data buffer,

at the time point when stopping, from the channel B, thereby transmitting.

In case when conducting the simultaneous transfer of the divided data with using a plural number of channels, there is the difference of the completion end time of the write-in into the data buffer among the plural number of the channels,

then recoding onto the optical disc is conducted in accordance with the order of the divided data to the contents, by adjusting the order of the readout from the data buffer,

but in the similar manner to the explanation in the embodiment 1,

the buffer controller 11 adjusts the order of transfer of the divided data onto the optical disc, by controlling the readout for the data buffer area,

in accordance with the correspondence between the sequence number for the divided data detected and the data buffer area, into which that divided data is written.

### Embodiment 3

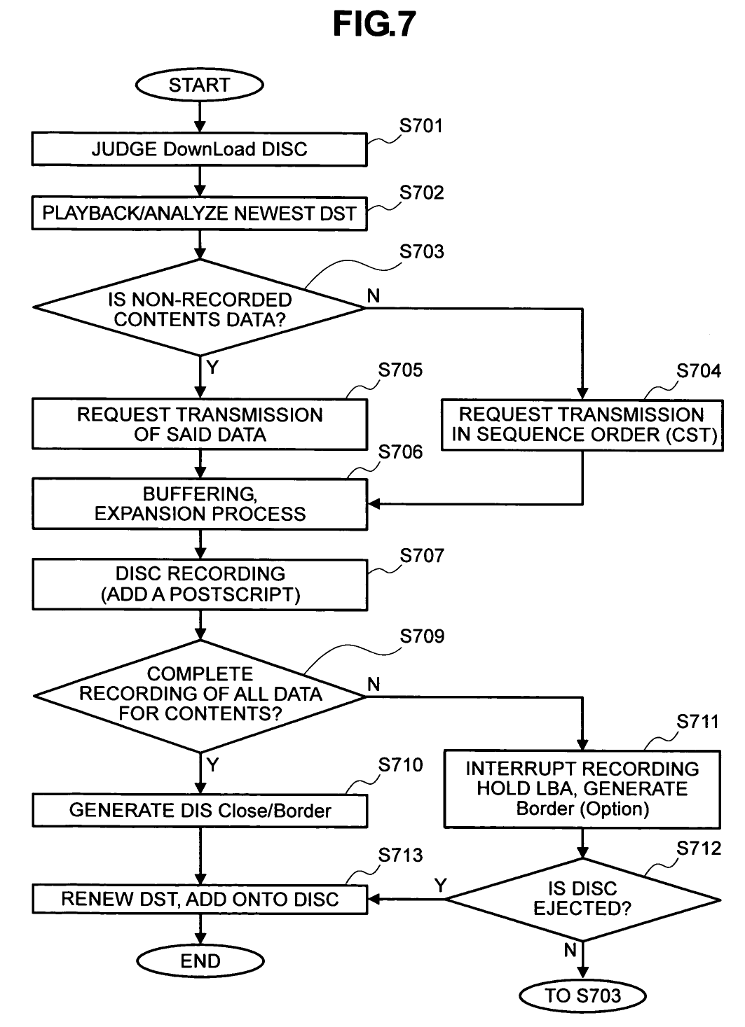

Next, explanation will be made on a method for managing the divided data and a recording-control method for the contents, which is executed when recording the transmitted data from the data buffer onto the optical disc, by referring to FIGS. 6(a) to 6(c) and FIG. 7.

FIG. 6(a) shows the area structures within a physical layer of the optical disc.

In this FIG. 6(a), PCA (Power Calibration Area) is an area for use in an adjustment of recording power of the optical head 2, to be conducted before the recording, and it is constructed with a lead-in area including the identification information for indicating a disc kind, etc., a user data area, into which the recording data is recorded, and a lead-out area indicating an end of the user area.

With an identification flag within the lead-in area,

for example, on a DVD-R disc, it is formed with pre-pits at the process of disc manufacturing, and identification information is recorded thereon, indicating that, for example, it is a disc for exclusive use, with which the contents on the server can be downloaded.

There can be considered cases of using it for disc identification when loading the optical disc, by detecting this identification information, and of using it for determining to allow the transfer of the data onto the optical disc, for the contents, which was explained in the embodiments 1 and 2.

With the lead-in and the lead-out other than that, no postscript can be made on the optical disc, i.e., the areas where recording is made when conducting the finalize (close) process.

FIG. 6(b) shows a case where three (3) times of the postscript is conducted as the recording onto the optical disc for the divided data.

In FIG. 6(b), the divided data 1 and 2 are recorded in the first recording,

and generated a recording status of the divided data for the contents and DST (Download Status Table) for managing the status,

and then an area is maintained in a part of the user data area, so as to record it therein.

Upon renewal and recording of DST, it is possible to grasp the newest recording status of the optical disc, and for example, once ejecting the optical disc from the drive apparatus on the way of the contents, and thereafter, it is possible to request the transmission of the divided data for the following contents, thereby enabling the postscript thereof.

In FIG. 6(b), DST is renewed and added, every time when recording thereafter, i.e., of the 2^{nd} time and the 3^{rd} time.

Generation of DST is conducted within the DST generator 13, and in addition to the information included within the headers of CST/CSH received are added the followings:

for example, the recording status information for indicating the recording status of each of the divided data onto the optical disc for the contents,

LBA (Logical Block Address) on the optical disc for the data, on which the transfer has already done, and further information that can grasp the recording status of all data for the contents (see FIG. 6(c)).

Also, not only the postscript, but there can be considered a case where the newest DST is overwritten on an old DST if the optical disc is re-writable one.

A DST area lies within the user data area, but it may be maintained in other area in FIG. 6(a).

Next, explanation will be made on the recording and postscript processes for the data transfer from the data buffer onto the optical disc, which is executed within the apparatus shown in FIG. 1, by referring to FIG. 7.

In FIG. 7, upon loading and reproduction of the lead-in area of the optical disc, which were explained by referring to FIGS. 6(a) to 6(c) before,

the detection result of the identification flag is transferred to the drive controller 15, and it is determined on whether it is a disc or not, onto which the contents data can be transferred (S701).

In case when it is determined to be the optical disc, onto which the contents data can be transferred, then an access is made to the DST area through the drive I/F circuit 9, so as to reproduce, and then the DST generator 13 executes an analysis of the newest table contents (S702).

In a step S703, if there is still remained the divided data non-recorded for the contents, according to the DST analysis, data transmission is requested to the contents server (S705), upon basis of the contents identification information, the sequence numbers and/or the link information, which are included in DST.

In case where there is remained no non-recorded portion for the contents data, and in particular, when other contents is added on the same disc,

or when it is determined that the optical disc is the non-recorded disc since no DST detection is conducted thereon,

then it is the case of transferred the contents to the optical disc, newly, from the head thereof, then the data transfer is requested,

in accordance with CST, which is transferred from the contents server 16, thereby transmitting the data onto the optical disc according to the order of sequences.

Following the steps S704 and S705, after conducting the buffering process by maintaining the data buffer for the data buffer 8, and the write-in and the readout of the transferred data, the readout the buffer control circuit 11 executes the transfer onto the optical disc (S706), and it starts postscript of the continuous divided data to the sequence numbers for the transfer data just before the postscript, which was already recorded on the optical disc (S707).

As the processes conducted within the data buffer can be applied the processes, which are explained by referring to FIGS. 3(a) to 3(c) and FIG. 4.

Further in a step S709, the transfer is determined of the last divided data for the contents, upon the sequence number included in DST or CST and CSH, or CEM detection, which was explained in FIG. 2(b) (S709),

and after completing the transfer of the last divided data, then the followings are conducted; i.e.,

the close (or finalize) process, including the postscript of the lead-out area therein, production of a boarder (i.e., session), as a boarder for the contents data on the optical disc (S710),

and further, renewal of DST and postscript thereof on the optical disc (S713), thereby ending the recording for the contents.

However, the step S710 does not execute the close process when recording other contents on the optical disc, and the border is produced, thereby maintaining the status of being able to make postscript onto the optical disc.

Also, in the renewal of DST, the recording status, i.e., integrated information of recording status for all data, is changed into “complete”,

and further the status corresponding to each of the divided data is changed to be already recorded,

thereby reflecting the fact that, there is no postscript data for the contents, upon DST.

Next, explanation will be made on the case where the recording is interrupted while remaining the recording onto the optical disc for the contents, in particular, in the step S709.

First of all, in a step S711, the controller 14 holds LBA, which interrupts the recording, temporarily.

Since there can be a case where the boarder is generated for the optical disc at this time point, as an option, it deals with information reproduction for the portion, which was already recorded, for the contents.

Further, in a step S712, when discharging the disc from the optical disc drive 6,

the process of S713 is executed, and the postscript control can be made on the non-recorded data within the contents, when loading the disc, again.

On the other hand, in case when staring the transfer control of the divided data again, without ejecting the disc in the step S712,

the process is started, again, from the step S703.

However, in case there is the non-recorded data for the contents, as the analysis result of DST in the step S702, there may be cases where the recording onto the optical disc of different contents is inhibited.

Determination on the inhibition of recording is made, by detecting inconsistency between the contents, which is transferred with using the contents identification information, such as, those included within CST transferred from the server and DST, which is recording on the optical disc, and the contents, which was already recorded on the optical disc, and in case where there is remained the non-recorded portion for the contents, judging from the recording status, then the postscript onto the optical disc is inhibited.

Also, in this case, there can be considered a case where the determining is made on the inhibition of recording, by calculating an optical disc capacity, which can be distributed to other contents to be transferred thereafter, from a total data volume of the non-recorded portion for the contents (this can be obtained from the volume information of DST) and the remaining disc capacitance, in which recording can be made on the optical disc, and in comparison with the data capacity necessary for the other contents, which can be obtained from CST.

Further, in this case, in particular, when it is possible to maintain the capacity for the other contents on the optical disc, there can be also considered a case where the transfer data for the other contents is added, after maintaining an area for that data capacity on the optical disc, by grasping the total data capacity of the non-recorded portion for the contents from DST on the way of recording onto the optical disc.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A data transmission method for a large amount of contents information, comprising the following steps of:
dividing contents data into a data block of fixed length or variable length, and conducting coding process on each thereof;
first header information for identifier of the contents, to which the data block belongs, and for managing sequence information within the contents, when transmitting the data block; and
transmitting second header information for managing the sequence within the contents of said data block, when transmitting each data block.

2. The data transmission method, as described in the claim 1, wherein
first end identifier indicating an end of the data block transfer, whenever transmitting the each data block,
and second end identifier indicating an end of contents when transmitting the data block including a contents end.

3. The data transmission method, as described in the claim 1, wherein
as the information, to be included within the first and the second header information,
are included information for identifying a recording medium of the transmission of contents, information relating to a coding method, which is treated on the data block,
and link information for identifying a source of the data block.

4. An optical disc apparatus for recording contents information onto an optical disc, while receiving the contents information through a network, comprising, at least:
an interface unit, which is configured to request data transmission to a source of contents, and to receive;
a detect unit, which is configured to detect header information including sequence information data blocks, each being a unit of transmission, within the contents;
a buffer unit, which is configured to accumulate the data blocks transmitted, temporarily, and to transmit them onto an optical disc; and
a buffer control unit, which is configured to control write-in and readout into/from said buffer unit, wherein
said buffer control unit maintains a buffer area and controls the write-in and the readout of the data block, by a unit of the data block received.

5. The optical disc apparatus, as described in the claim 4, wherein said buffer unit, for accumulating the data blocks, temporarily, is built up with, at least:
a first buffer area for the block data transmitted;
a second buffer area necessary for decoding of the data block; and
a third buffer area for storing therein transmission data onto an optical disc, wherein
said second and third buffer areas occupy a common area within said buffer unit.

6. The optical disc apparatus, as described in the claim 4, wherein said interface unit requests the transmission of the data block from a head of the contents data, sequentially, or request a plural number thereof, simultaneously, with using a plural number of transmission channels, and
said buffer control unit controls write-in of the data block received while maintaining a buffer area for the buffer unit; and
further, controls the readout into the buffer area while maintaining the sequence of the data blocks within the contents from sequence information, which can be obtained from the header detect unit,
and thereby controlling the transmission onto the optical disc.

7. An optical disc recording method, for dividing contents data into fixed length or variable length, receiving data blocks transmitted, and recording it onto an optical disc, being characterized in that:
including at least information indicative of a sequence of data blocks within contents,
further a recording table is generated by adding information for managing recording/non-recording upon recording condition of each of the data blocks on the optical disc,
to header information, which is transmitted with the data block, thereby recording it onto the optical disc.

8. The optical disc recording method, as described in the claim 7, wherein
the header information further includes link information for identifying a source of each data blocks, and the recording table is generated, including said information therein, thereby recording it onto the optical disc.

9. The optical disc recording method, as described in the claim 7, wherein
said header information further includes link information for identifying a source of each data blocks, and
determination is made on presence/absence of non-recorded data block for the contents, by reproducing the recording table on the optical disc,
and a transmission request is made to the source from the link information for said data block, in case that non-recorded data block presents,
and thereby conducting recording control for the data block transmitted.

10. An optical disc recording method, for dividing contents data into fixed length or variable length, receiving data blocks transmitted, and recording it onto an optical disc, comprises the following steps of:
producing a recording table from header information, at least including information of a sequence of data blocks within contents, and identification information for identifying the contents, which are transmitted with the data block, and recording it onto an optical disc;
comparing contents identification information managed on the recording table and contents identification information for the data block to be recorded onto the optical disc, through reproducing the recording table on the optical disc;
adding a data block responding to a coincidence of the identification information; and
inhibiting the postscript and protecting the contents data, which was already recorded onto the optical disc, responding to an inconsistency thereof.
